(19) United States
(12) Patent Application Publication
(10) Pub. No.: US 2014/0345263 A1
(43) Pub. Date: Nov. 27, 2014

(54) HYDRAULIC HYBRID DRIVE SYSTEM AND METHOD FOR OPERATING A HYDRAULIC HYBRID DRIVE SYSTEM

(71) Applicant: Robert Bosch GmbH, Stuttgart (DE)

(72) Inventors: Mirko Thulke, Ludwigsburg (DE); Elliot Morrison-Reed, Farmington Hills, MI (US); Dennis Heine, Sinsheim (DE); Sebastian Nuber, Kaarst (DE); Michael Senger, Freudental (DE)

(21) Appl. No.: 14/364,630

(22) PCT Filed: Dec. 13, 2012
(86) PCT No.: PCT/EP2012/075396

§ 371 Date: Jun. 11, 2014

(30) Foreign Application Priority Data
Dec. 16, 2011 (DE) 10 2011 121 500.3

(51) Int. Cl. B60K 6/12

(52) U.S. Cl. CPC B60K 6/12
USPC 60/327; 60/325

(57) ABSTRACT

The invention relates to a hydraulic hybrid drive system (1) for a motor vehicle, comprising driven wheels (2), which have friction brakes (3) for applying a friction braking torque to the driven wheels (2), and a continuously adjustable hydraulic transmission (4), which has a motor-side hydraulic machine (5) and a wheel-side hydraulic machine (6) having a direct fluid connection to the motor-side hydraulic machine, wherein the hydraulic machines (5, 6) are connected in series and to the driven wheels (2) of the motor vehicle in regard to driving, such that the hydraulic machines (5, 6) can be operated both as hydraulic pumps and as hydraulic motors, and at least one hydraulic fluid energy storage device (7), which is connected to the hydraulic transmission (4) in regard to fluid flow, wherein the motor-side hydraulic machine (5) is connected to the wheel-side hydraulic machine (6) in regard to fluid flow by means of a high-pressure hydraulic line (8) and a low-pressure hydraulic line (9). The invention further relates to a method for operating a hydraulic hybrid drive system (1).

### BACKGROUND OF THE INVENTION

The present invention concerns a hydraulic hybrid drive system for a motor vehicle with driven wheels, which have friction brakes for exerting a friction brake moment on the driven wheels, and a continuously adjustable hydraulic transmission, which comprises a motor-side hydraulic machine and a wheel-side hydraulic machine in direct fluidic connection therewith, wherein the hydraulic machines are connected in series and to the driven wheels of the motor vehicle for driving, so that the hydraulic machines can be operated both as hydraulic pumps and as hydraulic motors, and at least one hydraulic fluid energy storage device which is connected fluidically to the hydraulic transmission. Furthermore the invention concerns a method for operating a hydraulic hybrid drive system.

The area of application of the present invention is that of a hybrid vehicle with serial hydraulic drive train and a hydraulic fluid energy storage device, for operation on public roads.

Motor vehicles with hybrid drive for operation on public roads are in great demand because of the environmental benefits. The motor vehicles currently available on the market with hybrid drive all have electric hybrid drives, which comprise an internal combustion engine and at least one electrical machine which can be operated both as an electric motor and as an electrical generator, and an electrical storage device. Instead of an electrical storage device, hydraulic hybrid drive systems have a hydraulic fluid energy storage device which stores pressurized fluid, and a hydraulic machine which can be operated both as a hydraulic pump and as a hydraulic motor. When operating as a hydraulic pump, the hydraulic machine assumes the function of an electrical generator and feeds energy into the storage device. When operating as a hydraulic motor, the hydraulic machine corresponds to an electric motor which drives the driven wheels.

An operating strategy for a hybrid vehicle with serial electric drive train is generally known prior art. The motor control system of an electric hybrid vehicle contains a torque controller and torque distribution system, and an operating strategy which is oriented to the electrical storage device and the electric machine. The particular features of an electric drive train are taken into account both at transitions between different operating states and in coordination of the moments. In the switch from charging to discharging of the electrical storage device, inductances and capacitances limit the achievable switching times. However an electrical storage device can be switched into the onboard network or isolated therefrom independently of its charging state and the amount of the momentary current flow.

Parallel hydraulic hybrid systems which have a hydraulic fluid energy storage device but not a hydraulic drive train are also prior art, and are used in particular in HRB (hydrostatic regenerative brake system) refuse collection vehicles.

WO 2006/055978 A1 discloses an electrohydraulic hybrid drive system for a motor vehicle in which an electrical machine, which can be operated both as an electric motor and as an electrical generator, is driven by an internal combustion engine. The electrical machine is operationally connected via a direct coupling to a first of two hydraulic machines which together form a hydraulic transmission, wherein the electrical machine and the motor-side hydraulic machine are coupled in parallel with the internal combustion engine. A hydraulic fluid energy storage device, which is connected fluidically with the hydraulic transmission, is used for energy storage together with an electric battery and supercondenser bank, which are connected operationally to the electrical machine.

### SUMMARY OF THE INVENTION

Starting from the abovementioned prior art, the object of the present invention is to improve a hydraulic hybrid system in that the motor-side hydraulic machine is connected fluidically to the wheel-side hydraulic machine via a high-pressure hydraulic line and a low-pressure hydraulic line.

The object is achieved starting from a hydraulic hybrid drive system according to the invention.

According to the invention, the hydraulic fluid energy storage device is connected fluidically to the high-pressure hydraulic line. This allows evacuation of the hydraulic fluid energy storage device, which reduces the load on the internal combustion engine and leads to an associated fuel saving. Evacuation of the hydraulic fluid energy storage device drives the wheel-side hydraulic machine, which in turn transmits the drive torque to the driven wheels via a shaft.

Preferably an internal combustion engine is coupled to the motor-side hydraulic machine via a clutch. In this way the combustion engine transfers the torque generated to the motor-side hydraulic machine, which in turn conducts the torque to the driven wheels via the high-pressure hydraulic line and the wheel-side hydraulic machine. The internal combustion engine can be operated independently of the current wheel torque, thanks to this arrangement and an operating strategy, wherein the combustion engine works at an optimum rotation speed and hence has a high efficiency. If the torque from the internal combustion engine is not required, its operation can be stopped.

To operate the hydraulic hybrid drive system described above, furthermore a method is specified with which operating states for pressure and flow adaptation are applied before and after a thrust mode in order to prevent pressure pulses and shock waves in the hydraulic hybrid drive system, wherein thrust mode is implemented by a discharge of the hydraulic fluid energy storage device. This is necessary in particular to connect the storage device to the hydraulic hybrid drive system. Due to the high pressure which is stored in the hydraulic fluid energy storage device at high charge state, opening the hydraulic fluid energy storage device to relieve the load on the internal combustion engine causes a pressure pulse in the high-pressure hydraulic line, since the high-pressure hydraulic line currently has a lower pressure than the hydraulic fluid energy storage device. This pressure pulse would be clearly perceptible to the occupants of the motor vehicle and would be perceived as unpleasant.

The advantage of the present solution according to the invention is in particular that the motor vehicle is operated with at least one thrust mode, at least one pre-thrust mode, at least one post-thrust mode and/or at least one regenerative braking mode. These operating modes serve for acceleration and braking of the motor vehicle. In addition a creep process is provided which is initiated when the brake pedal is released and the gear selector lever is set to position D (forward) or R (reverse). Here a calibratable minimum torque is conducted to the wheels via the wheel-side hydraulic machine, whereby a very low vehicle speed is achieved. In a basic mode, the internal combustion engine drives the motor-side hydraulic machine, wherein the motor-side hydraulic machine meets the need for pressure in the high-pressure hydraulic line of the wheel-side hydraulic machine, which provides the torque for the driven wheels.

Preferably before the thrust mode, the pre-thrust mode is applied, wherein the pressure in a high-pressure hydraulic line is adapted to the pressure in the hydraulic fluid energy storage device. This pressure adaptation prevents pressure pulses in the high-pressure hydraulic line. Pre-thrust mode is initiated when thrust mode is activated by release conditions, the driver's demand for torque exceeds a limit value, and the pressure of the hydraulic fluid energy storage device is significantly higher than the pressure in the high-pressure hydraulic line. The pressure from the hydraulic fluid energy storage device makes a positive torque contribution.

According to a measure which improves the invention further, to adapt the pressure in the high-pressure hydraulic line, a virtual idle torque is calculated which is provided by a flow adaptation of the wheel-side hydraulic machine. The pressure in the high-pressure hydraulic line rises constantly so that when a pressure level corresponding to the pressure level of the hydraulic fluid energy storage is reached, a valve in the hydraulic fluid energy storage device is opened, whereby the high-pressure hydraulic line is fed with the pressure from the hydraulic fluid energy storage device. This relieves the load on the internal combustion engine, which is reflected in a fuel saving. During thrust mode, the pressure in the high-pressure hydraulic line reduces according to the reduction in pressure in the hydraulic fluid energy storage device, since the motor-side hydraulic machine does not generate pressure in thrust mode.

It is furthermore proposed that after the thrust mode, a post-thrust mode is applied in which a discharge of the hydraulic fluid energy storage device and the associated pressure fall in the high-pressure hydraulic line are compensated by connection of the motor-side hydraulic machine. During post-thrust mode, the motor-side hydraulic machine is activated and again begins to generate pressure for the high-pressure hydraulic line. The intention is to slow down the line pressure fall and gently stop the storage flow.

Preferably, the motor-side hydraulic machine is connected when the hydraulic fluid energy storage device has a charge state of less than 30%. A charge state of less than 30% is associated with a specific limit value of the pressure in the high-pressure hydraulic line and initiates post-thrust operation. By absorbing the pressure drop, a pressure pulse is prevented when drive returns to a fully discharged high-pressure hydraulic line, which results from a fully discharged hydraulic fluid energy storage device. Post-thrust mode is replaced by basic mode as soon as the pressure in the high-pressure line reaches a limit value and the charge state of the hydraulic fluid energy storage device falls below a limit value.

Furthermore, preferably the regenerative braking mode is provided for charging the hydraulic fluid energy storage device, wherein the wheel-side hydraulic machine functions as a hydraulic pump, whereby the pressure and hence also the energy in the hydraulic fluid energy storage device are increased. Regenerative braking mode is dependent on the negative wheel torque required, certain release conditions and a minimum time. This mode is exited as soon as the charge state of the hydraulic fluid energy storage device exceeds a limit value, one of the release conditions is not fulfilled, the negative wheel torque required exceeds a limit value, or the vehicle speed falls below a limit value. After activation of the regenerative braking process, a hybrid control device transmits the current regenerative braking torque to a brake motor control device. The brake motor control device distributes the remaining torque to the friction brakes so that the braking torque required is composed from the current regenerative braking torque and the friction braking torque.

### BRIEF DESCRIPTION OF THE DRAWINGS

Further features improving the invention are described in more detail below together with the description of a preferred exemplary embodiment of the invention with reference to the figures.

The drawings show:

FIG. 1 a diagrammatic depiction of a hydraulic hybrid drive system according to the invention, and

FIG. 2 a flow diagram to depict the method according to the invention for operating a hydraulic hybrid drive system.

### DETAILED DESCRIPTION

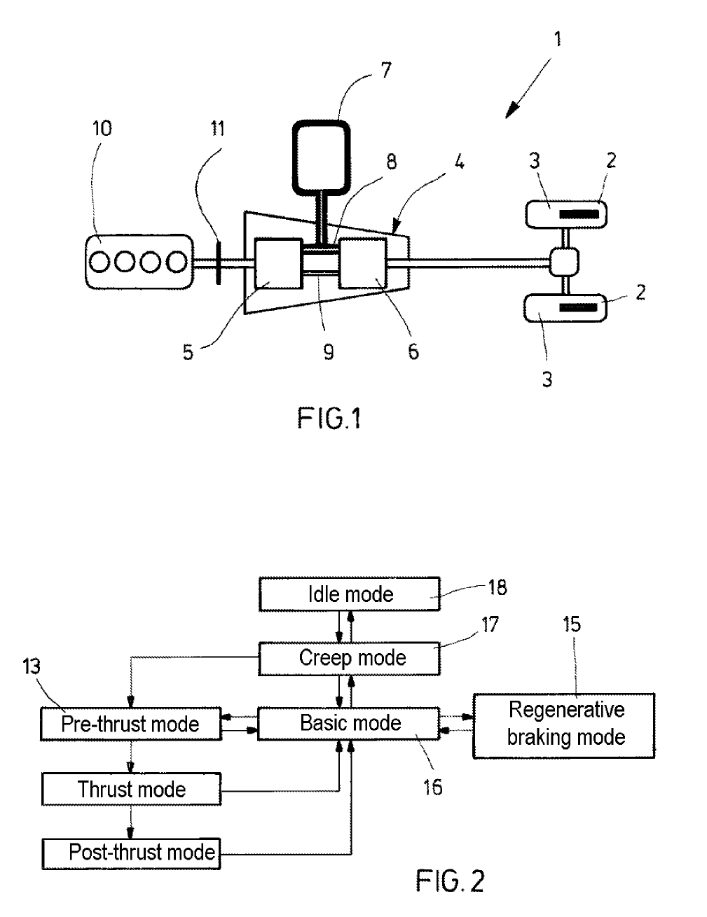

According to FIG. 1, the hydraulic hybrid drive system 1 according to the invention for a motor vehicle consists of driven wheels 2, friction brakes 3 for exerting a friction braking moment on the driven wheels 2, and a continuously adjustable hydraulic transmission 4 which comprises a motor-side hydraulic machine 5 and a wheel-side hydraulic machine 6 in direct fluidic connection therewith. The hydraulic machines 5, 6 are connected in series and to the driven wheels 2 of the motor vehicle for driving, so that the hydraulic machines 5, 6 can be operated both as hydraulic pumps and as hydraulic motors. Furthermore a hydraulic fluid energy storage device 7 is connected fluidically to the hydraulic transmission 4 via a high-pressure hydraulic line 8. The motor-side hydraulic machine 5 is connected fluidically to the wheel-side hydraulic machine 6 via the high-pressure hydraulic line 8 and the low-pressure hydraulic line 9. An internal combustion engine 10 is coupled via a clutch 11 to the motor-side hydraulic machine 5 and drives this.

According to FIG. 2, after engine start, the motor vehicle is in idle mode 18. When a gear is engaged, the vehicle transfers to creep mode 17, whereby a small torque is transmitted to the driven wheels 2. From creep mode, the motor vehicle can shift either to basic mode 16 or to pre-thrust mode 13, wherein the choice of operating state is dependent on several factors.

In basic mode 16, the internal combustion engine 10 feeds the high-pressure hydraulic line 8 via the motor-side hydraulic machine 5 and thus drives the wheel-side hydraulic machine 6, which in turn drives the driven wheels 2.

During pre-thrust mode 13, the pressure in the high-pressure hydraulic line 8 is adapted to the pressure in the hydraulic fluid energy storage device 7, insofar as the hydraulic fluid energy storage device 7 has a sufficiently high charge state. To adapt the pressure in the high-pressure hydraulic line 8, a virtual idle torque is calculated which is provided by a flow adaptation of the wheel-side hydraulic machine 6.

After the pre-thrust mode 13, thrust mode 12 is initiated. During thrust mode 12, the pressure in the high-pressure hydraulic line 8 reduces according to the reduction in pressure in the hydraulic fluid energy storage device 7, since the motor-side hydraulic machine 5 does not generate pressure in thrust mode.

When the hydraulic fluid energy storage device 7 has a charge state of less than 30%, post-thrust mode 14 is initiated. During post-thrust mode 14, the motor-side hydraulic machine 5 is activated and begins to generate pressure again for the high-pressure hydraulic line 8, in order to slow down the line pressure fall and gently stop the storage flow.

A transition to basic mode 16 is possible both from thrust mode 12 and from post-thrust mode 14.

Regenerative braking mode 15 is reached from basic mode 16. This serves to charge the hydraulic fluid energy storage device 7, wherein the wheel-side hydraulic machine 6 functions as a hydraulic pump, whereby the pressure and hence also the energy in the hydraulic fluid energy storage device 7 is increased.

1. A hydraulic hybrid drive system (1) for a motor vehicle with driven wheels (2), which have friction brakes (3) for exerting a friction brake moment on the driven wheels (2), and a continuously adjustable hydraulic transmission (4), which comprises a motor-side hydraulic machine (5) and a wheel-side hydraulic machine (6) in direct fluidic connection therewith, wherein the hydraulic machines (5, 6) are connected in series and to the driven wheels (2) of the motor vehicle for driving, so that the hydraulic machines (5, 6) can be operated both as hydraulic pumps and as hydraulic motors, and at least one hydraulic fluid energy storage device (7) which is connected fluidically to the hydraulic transmission (4), characterized in that the motor-side hydraulic machine (5) is connected fluidically to the wheel-side hydraulic machine (6) via a high-pressure hydraulic line (8) and a low-pressure hydraulic line (9).

2. The hydraulic hybrid drive system (1) as claimed in claim 1, characterized in that the hydraulic fluid energy storage device (7) is connected fluidically to the high-pressure hydraulic line (8).

3. The hydraulic hybrid drive system (1) as claimed in claim 1, characterized in that an internal combustion engine (10) is coupled to the motor-side hydraulic machine (5) via a clutch (11).

4. A method for operating a hydraulic hybrid drive system (1) as claimed in claim 1, characterized in that operating states for pressure and flow adaptation are applied before and after a thrust mode (12), in order to prevent pressure pulses and shock waves in the hydraulic hybrid drive system (1), wherein thrust mode (12) is implemented by a discharge of the hydraulic fluid energy storage device (7).

5. The method as claimed in claim 4, characterized in that the motor vehicle is operated with at least one thrust mode (12), at least one pre-thrust mode (13), at least one post-thrust mode (14) and/or at least one regenerative braking mode (15).

6. The method as claimed in claim 4, characterized in that before the thrust mode (12), a pre-thrust mode (13) is applied, wherein the pressure in a high-pressure hydraulic line (8) is adapted to the pressure in the hydraulic fluid energy storage device (7).

7. The method as claimed in claim 4, characterized in that to adapt the pressure in the high-pressure hydraulic line (8), a virtual idle torque is calculated which is provided by a flow adaptation of the wheel-side hydraulic machine (6).

8. The method as claimed in claim 4, characterized in that after the thrust mode (12), a post-thrust mode (14) is applied in which a discharge of the hydraulic fluid energy storage device (7) and the associated pressure fall in the high-pressure hydraulic line (8) are compensated by connection of the motor-side hydraulic machine (5).

9. The method as claimed in claim 4, characterized in that the motor-side hydraulic machine (5) is connected when the hydraulic fluid energy storage device (7) has a charge state of less than 30%.

10. The method as claimed in claim 4, characterized in that the regenerative braking mode (15) is provided for charging the hydraulic fluid energy storage device (7), wherein the wheel-side hydraulic machine (6) functions as a hydraulic pump, whereby the pressure and hence also the energy in the hydraulic fluid energy storage device (7) are increased.

11. The method as claimed in claim 4, characterized in that the motor vehicle is operated with at least one thrust mode (12).

12. The method as claimed in claim 4, characterized in that the motor vehicle is operated with at least one pre-thrust mode (13).

13. The method as claimed in claim 4, characterized in that the motor vehicle is operated with at least one post-thrust mode (14).

14. The method as claimed in claim 4, characterized in that the motor vehicle is operated with at least one regenerative braking mode (15).
